(19) United States
(12) Patent Application Publication
(10) Pub. No.: US 2015/0113923 A1
(43) Pub. Date: Apr. 30, 2015

(54) Horse Mask and Visor

(71) Applicant: Robin Wood, Earlysville, VA (US)

(72) Inventor: Robin Wood, Earlysville, VA (US)

(21) Appl. No.: 14/493,639

(22) Filed: Sep. 23, 2014

Related U.S. Application Data
(60) Provisional application No. 61/897,635, filed on Oct. 30, 2013.

(51) Int. Cl. A01K 13/00

(52) U.S. Cl. CPC A01K 13/006
USPC 54/80.2

(57) ABSTRACT

A horse mask having a removable visor is provided. The horse mask is composed of a flexible mesh material and is adapted to substantially cover a horse's head. The horse mask comprises an opening thereon corresponding to the location of the horse's eyes and area therebetween. The opening includes a fastener disposed about the perimeter thereof to which a visor can be removably secured. The visor is transparent and serves to shield the horse's eyes from exposure to ultraviolet radiation. Preferably, the visor is secured to the opening of the mask using hook and loop fastening material. The mask further includes a pair of pockets having an interior volume in which a horse's ears can be positioned. The mask can be secured on a horse by overlapping portions of the mask on an underside of the horse's head.

### CROSS REFERENCE TO RELATED APPLICATION

This application claims the benefit of U.S. Provisional Application No. 61/897,635 filed on Oct. 30, 2013, entitled “Horse Shades.” The above identified patent application is herein incorporated by reference in its entirety to provide continuity of disclosure.

### BACKGROUND OF THE INVENTION

1. Field of the Invention

The present invention relates to a horse fly mask and visor. More specifically, the present invention provides a horse fly mask adapted to cover a head of a horse, and having an opening corresponding to the location of the horse's eyes and area therebetween. A transparent visor composed of an ultraviolet radiation shielding material or having an ultraviolet radiation shielding coating thereon can be removably secured over the opening on the mask by means of fasteners disposed on the perimeter of the opening on the visor.

Horse owners commonly fit their horses with fly masks that help to protect the horse's eyes, jaw, and ears from biting insects. Biting insects may be annoying for the horse, and can cause the horse to become agitated or angry. Further, biting insects transmit diseases and can cause the horse to become sick. Accordingly, horse owners often place horse fly masks on their horses. Such masks are composed of a mesh material that provides the horse with some visibility and does not interfere with the horse's hearing.

Furthermore, some horses suffer from eye conditions, such as uveitis and ulcerated eyes, among others. As a result, these horses must often be restricted to a stable or stall so as to prevent the horse's eye problems from being worsened by exposure to ultraviolet radiation and the sun's rays. Further, without eye protection, the horses may get dirt or debris in their eyes, causing irritation and possibly causing a more serious eye condition.

The present invention provides a horse fly mask having an opening thereon corresponding to the location of the horse's eyes. The horse fly mask is adapted to be removably secured to a horse so as to cover the horse's eyes, jaw, and muzzle. Thus, the horse fly mask does not cover the horse's nose or mouth. The horse fly mask is removably secured about the horse's head using hook and loop fastening material, or another suitable fastener. The horse fly mask is preferably composed of a mesh material that is lightweight and breathable, and that does not interfere with the horse's hearing when placed over the horse's ears. A visor that shields against ultraviolet radiation can be removably secured about the opening via hook and loop fastening material. The visor prevents dirt and debris from contacting the horse's eyes and protects the horse's eyes from ultraviolet radiation.

2. Description of the Prior Art

Devices have been disclosed in the prior art that relate to horse masks and coverings. These include devices that have been patented and published in patent application publications. These devices generally relate to horse masks and coverings for protecting a horse from biting insects. The following is a list of devices deemed most relevant to the present disclosure, which are herein described for the purposes of highlighting and differentiating the unique aspects of the present invention, and further highlighting the drawbacks existing in the prior art.

One such device, U.S. Pat. No. 8,127,521 to Cates discloses an equine mask and visor adapted to protect a horse's eyes and face. A layer of UV-opaque material is disposed on a UV-retarding mesh screen layer so as to form a sun visor to shield the horse's eyes from direct sunlight. The UV-opaque layer still allows a horse to see therethrough so as to not impede the horse's vision. Thus, Cates fails to disclose a mask having an opening corresponding to the portion of the mask surrounding the horse's eyes, and does not disclose a removable visor.

U.S. Pat. No. 6,128,891 to McMahon discloses a protective mask for a horse. The mask comprises a cap shaped to conform to a top portion of a horse's head. A mesh face panel is secured to a bottom portion of the cap and extends therefrom to cover the eyes of the horse. A nosepiece is secured to the face panel and spans the bridge of the horse's nose. Straps are coupled to opposite edges of the face panel and are securable under the horse's head. Thus, while McMahon discloses a face mask for a horse, McMahon does not disclose a removable visor and a mask having an opening thereon adapted to receive a visor.

U.S. Pat. No. 7,100,349 to Andrews discloses a horse mask securable to a bridle. The horse mask includes a cover member composed of a plastic screen material that extends between the brow band, nose band, and cheek pieces of a bridle. The mask can be removably secured to the bridle via a fastener, such as hook and loop fastening material. Two support members help to space the mask from the horse's eyes. Thus, Andrews discloses a horse mask, but requires a horse to have a bridle thereon. Andrews fails to disclose a horse mask that can be worn independently from a bridle, and that includes a removable visor.

U.S. Pat. No. 4,581,877 to Wilber discloses a protective eye covering for a horse. The device includes a hood with ear openings and eye openings thereon. An eye opening can include a semi-rigid cup thereon and an interior portion with a gauze pad for maintaining an animal's eye in a closed position. The invention helps to keep an animal's eye closed in order to allow the animal's eye to heal if it is injured or infected. Thus, Wilber discloses a device for maintaining an animal's eye shut, and does not disclose a mask having a removable visor for protecting the horse's eyes from exposure to ultraviolet rays or debris.

Finally, U.S. Pat. No. 3,104,508 to O'Hare Jr. discloses a fly mask for cows and other animals. The mask is composed of a hard plastic that fits over the head of an animal and includes a slot across the front thereof corresponding to the location of the animal's eyes. The slot is covered by a screen that allows the animal to see therethrough. Another slot is disposed on a lower portion of the mask and includes a nose plate thereon. A pair of straps are used to securely attach the mask onto the animal's head. Thus, O'Hare Jr. discloses a rigid, inflexible mask which may be uncomfortable for an animal and that does not allow air to flow therethrough. Further, O'Hare Jr. fails to disclose a removable visor that can be secured to the mask.

These prior art devices have several known drawbacks. The devices in the prior art relate to horse masks that protect a horse's face from debris and biting insects. While these conventional masks are composed of mesh so as to allow a horse to see therethrough, the mask impairs the horse's vision to some degree. Further, such masks are not adapted to block ultraviolet rays, and thus the horse's eyes may still be damaged from such exposure. Devices in the prior art do not include removable visors for protecting a horse's eyes from ultraviolet rays and that also helps to block debris from contacting the horse's face and eyes.

In light of the devices disclosed in the prior art, it is submitted that the present invention substantially diverges in design elements from the prior art and consequently it is clear that there is a need in the art for an improvement to existing horse mask and visor devices. In this regard the instant invention substantially fulfills these needs.

### SUMMARY OF THE INVENTION

In view of the foregoing disadvantages inherent in the known types of horse fly masks now present in the prior art, the present invention provides a new horse mask and visor wherein the same can be utilized for providing convenience for the user when shielding a horse's face and eyes from debris, insects, and ultraviolet radiation.

It is therefore an object of the present invention to provide a new and improved horse mask and visor device that has all of the advantages of the prior art and none of the disadvantages.

It is another object of the present invention to provide a horse mask and visor device that protects a horse's eyes and face from exposure to dirt, debris, and biting insects.

Another object of the present invention is to provide a horse mask and visor device that can be easily removably secured to a horse's head.

Yet another object of the present invention is to provide a horse mask and visor device that includes an opening thereon on which a visor can be removably positioned.

Another object of the present invention is to provide a horse mask and visor device comprising a visor that shields the horse's eyes from ultraviolet radiation while allowing the horse to see clearly therethrough.

A further object of the present invention is to provide a horse mask and visor device that may be readily fabricated from materials that permit relative economy and are commensurate with durability.

Other objects, features and advantages of the present invention will become apparent from the following detailed description taken in conjunction with the accompanying drawings.

### BRIEF DESCRIPTIONS OF THE DRAWINGS

Although the characteristic features of this invention will be particularly pointed out in the claims, the invention itself and manner in which it may be made and used may be better understood after a review of the following description, taken in connection with the accompanying drawings wherein like numeral annotations are provided throughout.

FIG. 1 shows a perspective view of an embodiment of the horse mask and visor of the present invention as worn by a horse.

FIG. 2 shows a rear perspective view of an embodiment of the horse mask and visor of the present invention.

FIG. 3 shows a rear perspective view of an embodiment of the visor of the present invention.

FIG. 4 shows a perspective view of the visor as positioned to be secured on the mask of the present invention.

### DETAILED DESCRIPTION OF THE INVENTION

Reference is made herein to the attached drawings. Like reference numerals are used throughout the drawings to depict like or similar elements of the horse mask and visor of the present invention. For the purposes of presenting a brief and clear description of the present invention, the preferred embodiment will be discussed as used for protecting a horse's face and eyes from dirt, biting insects, and ultraviolet radiation. The figures are intended for representative purposes only and should not be considered to be limiting in any respect.

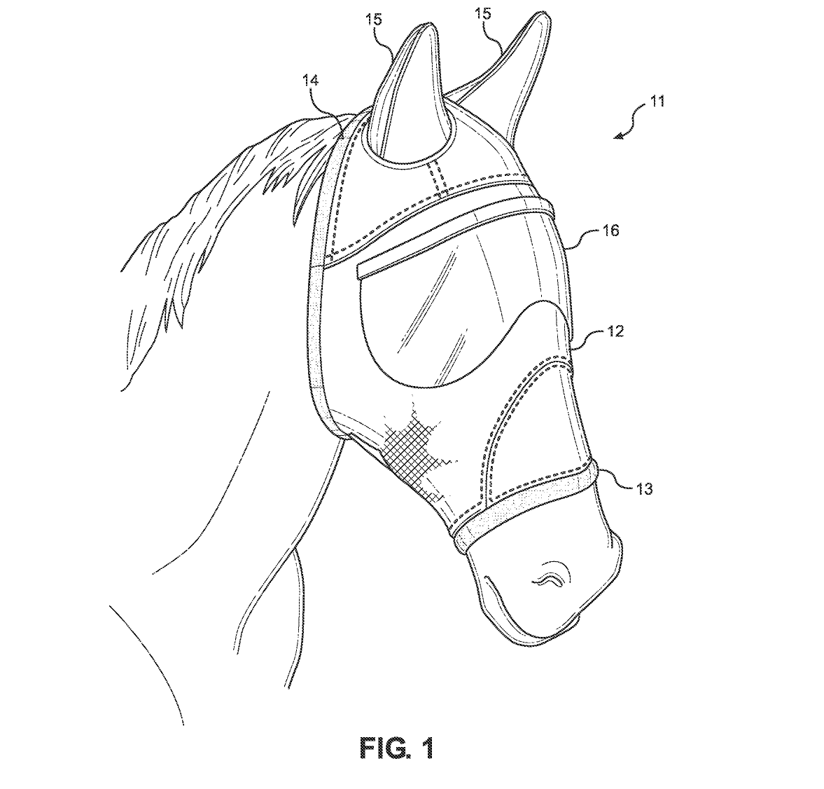

Referring now to FIG. 1, there is shown a perspective view of an embodiment of the horse mask and visor of the present invention as worn by a horse. The horse mask 11 of the present invention comprises a mask 12 adapted to cover a portion of the head of a horse. The mask 12 includes an upper end 14 and a lower end 13. The lower end 13 is adapted to be wrapped around the muzzle of the horse and secured underneath the mouth or jaw of the horse. Thus, the lower end 13 of the mask 12 does not enclose the horse's nose or mouth. The lower end 13 fits closely to the horse's head so that insects cannot crawl underneath the mask 12 and onto the horse's face. The upper end 14 of the mask 12 is adapted to be secured about the horse's head adjacent to the neck of the horse. The mask 12 includes a pair of pockets 15 having an interior volume suited to receive a horse's ears therein. The pockets 15 are positioned on an upper end of the mask 12 in an area corresponding to the location of a horse's ears. The mask 12 is preferably composed of a mesh material that is breathable so as to allow air to flow therethrough. Further, the mask 12 is composed of a lightweight, non-abrasive material that can be comfortably worn on the horse's head.

The mask 12 includes an opening thereon corresponding to the location of the horse's eyes and the area therebetween. A visor 16 can be removably secured to the mask 12 so that it covers the opening. More specifically, the perimeter of the opening on the visor 16 is removably secured to the perimeter of the opening on the mask 12. The visor 16 comprises a lens adapted to protect the horse's eyes from exposure to ultraviolet radiation, while allowing a horse to see clearly therethrough. The lens is preferably composed of glass or plastic, such as poly-methyl methacrylate, polycarbonate, polyurethane, or other suitable material. The visor 16 includes an arcuate shape so as to conform to the curvature of the horse's head. Further, the visor 16 includes a pair of widened regions corresponding to the area covering the horse's eyes, and a narrow region connecting the two widened regions adapted to be disposed in the area between the horse's eyes. The shape of the visor 16 helps to provide the horse with a wide field of vision, and ensures that the horse's vision is not obscured by the mask.

The visor 16 is adapted to block ultraviolet rays from entering the horse's eyes. The visor 16 may be tinted or can include a reflective coating thereon. Further, the visor may be polarized so as to reduce glare. This helps to protect the horse's eyes from damage from being outside in the sun for an extended period of time. Further, the visor 16 allows a horse having an injured eye to spend time outdoors without further irritating or injuring the horse's eyes as result to exposure to ultraviolet radiation and debris.

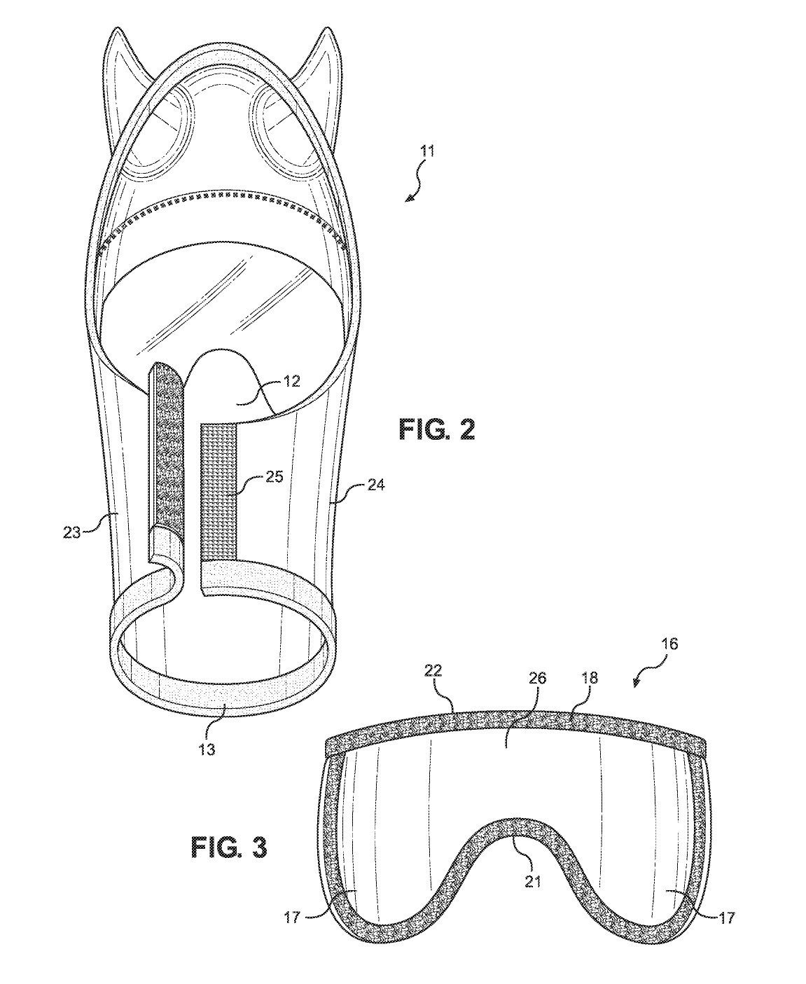

Referring now to FIG. 2, there is shown a rear perspective view of an embodiment of the horse mask and visor of the present invention. The mask 12 comprises a first portion 23 and a second portion 24 on a lower end 13 of the mask 12. The first and second portions 23, 24 each comprise a fastener 25 thereon. The first and second portions 23, 24 are adapted to be wrapped around a portion of the horse's head and secured to one another in an overlapping position via the fasteners 25 thereon. The fasteners 25 preferably include hook and loop fastening material, however, other suitable fasteners may be used including snaps, buttons, or ties, among others. Thus, a user can easily position the mask 12 over a horse's head, and can then secure the first and second portions 23, 24 together on the underside of the horse's head.

Referring now to FIG. 3, there is shown a rear perspective view of an embodiment of the visor of the present invention. The visor 16 of the present invention is transparent so that a horse can easily see therethrough. The visor 16 comprises an arcuate shape so as to conform to the shape of the horse's head. Thus, the visor 16 is adapted to extend between opposing sides of a horse's head. The visor 16 includes a pair of eye portions 17 that are widened, and a central portion 26 that is relatively narrow and extends between the eye portions 17. The upper edge of the visor 16 is substantially straight, and the lower edge of the visor 16 includes a curved shape with an indented region 21 between the eye portions 17 of the visor 16. The perimeter of the interior surface of the visor 16 includes fasteners 18 thereon. Preferably, the fasteners 18 include hook and loop fastening material. The fasteners 18 can be disposed entirely around the perimeter of the visor 16 or around only a portion thereof.

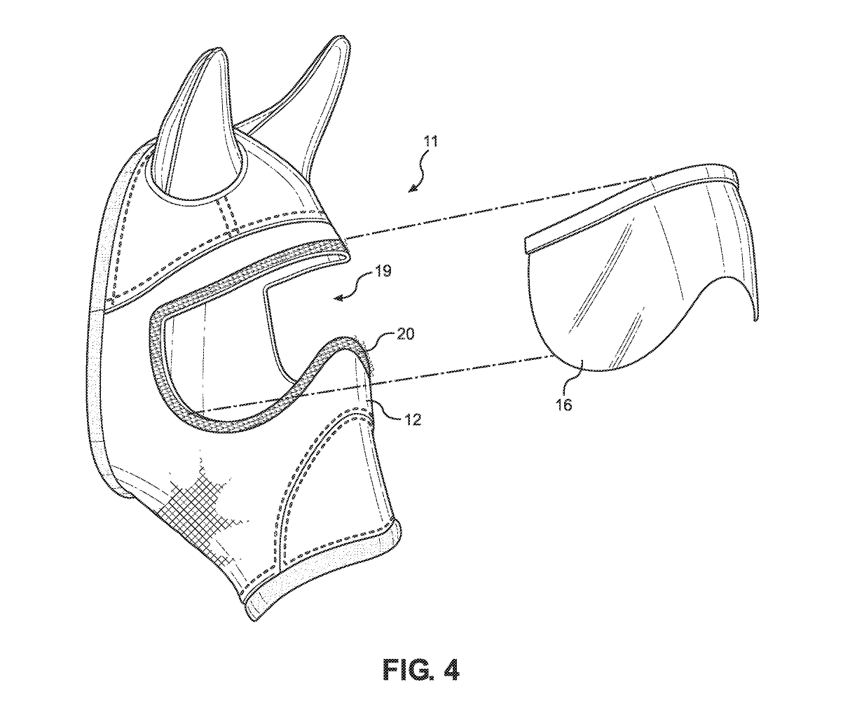

Referring now to FIG. 4, there is shown a perspective view of the visor as positioned to be secured on the mask of the present invention. The mask 12 includes an opening 19 thereon corresponding to the location of the horse's eyes and area therebetween. The perimeter of the opening 19 includes fasteners 20 thereon adapted to engage with fasteners on an interior surface of the visor 16. The fasteners 20 may be disposed about the entire perimeter of the opening 19 so as to form a seal about the opening. The visor 16 can be aligned with the fasteners 20 on the mask 12 and secured thereto by engaging the fasteners. This allows a horse to wear a mask 12 with the visor 16, or without the visor 16 as desired by the user. Further, the removable visor allows a user to interchange the visor 16 with alternate visors 16 having various properties, such as tinted lenses, reflective coatings, and glare reducing coatings.

It is therefore submitted that the instant invention has been shown and described in what is considered to be the most practical and preferred embodiments. It is recognized, however, that departures may be made within the scope of the invention and that obvious modifications will occur to a person skilled in the art. With respect to the above description then, it is to be realized that the optimum dimensional relationships for the parts of the invention, to include variations in size, materials, shape, form, function and manner of operation, assembly and use, are deemed readily apparent and obvious to one skilled in the art, and all equivalent relationships to those illustrated in the drawings and described in the specification are intended to be encompassed by the present invention.

Therefore, the foregoing is considered as illustrative only of the principles of the invention. Further, since numerous modifications and changes will readily occur to those skilled in the art, it is not desired to limit the invention to the exact construction and operation shown and described, and accordingly, all suitable modifications and equivalents may be resorted to, falling within the scope of the invention.

I claim:

1) A horse mask and visor, comprising:
a mask adapted to cover a portion of a horse's head;
an opening on said mask extending between opposing sides of said mask and corresponding to an area surrounding a horse's eyes;
a fastener disposed about a perimeter of said opening;
a visor;
wherein said visor comprises a fastener disposed about a perimeter thereof, wherein said fastener on said visor is adapted to be removably secured to said fastener on said opening on said mask.

2) The horse mask and visor of claim 1, wherein
said mask further comprises a first portion and a second portion adapted to be wrapped around said horse's head, and secured in an overlapping configuration by means a fastener thereon.

3) The horse mask and visor of claim 1, wherein said mask is composed of a mesh material.

4) The horse mask and visor of claim 1, wherein said visor comprises a lens adapted to block ultraviolet radiation from passing therethrough.

5) The horse mask and visor of claim 1, wherein said visor comprises an arcuate shape so as to conform to the shape of a horse's head.

6) The horse mask and visor of claim 1, further comprising a pair of pockets disposed on said upper portion of said mask, said pockets adapted to conform to a horse's ears.

7) The horse mask and visor of claim 1, wherein said fastener on said visor comprises hook and loop fastening material, and wherein said fastener on said opening of said mask comprises hook and loop fastening material.

8) The horse mask and visor of claim 1, wherein said fastener on said opening of said mask is disposed about an entire perimeter of said opening.
